(19) United States
(12) Patent Application Publication
(10) Pub. No.: US 2006/0131452 A1
(43) Pub. Date: Jun. 22, 2006

(54) Electric motor operated kitchen device

(76) Inventor: Uwe Caldewey, Dortmund (DE)

Correspondence Address: Martin A Farber, 866 United Nations Plaza, Suite 473, New York, NY, 10017, US

(21) Appl. No.: 10/515,069

(22) PCT Filed: Apr. 3, 2003
(86) PCT No.: PCT/EP03/03457

§ 371 Date: Aug. 8, 2005

(30) Foreign Application Priority Data
May 21, 2002 (DE) 102 22 376.9

(51) Int. Cl. B02C 25/00

(52) U.S. Cl. 241/36

(57) ABSTRACT

Electric moto operated kitchen device, especially a food processor, with a mixing vessel, the electric motor preferably being a reluctance motor, characterized in that a residual current sensor is disposed in the kitchen device and interrupts the current supply at least of the electric motor is a residual current is detected.

The invention relates in first instance to an electric motor operated kitchen device, especially a food processor, with a mixing vessel, the electric motor preferably being a reluctance motor.

Kitchen devices, especially food processors, of the type in question are known in various forms. They generally have an electric motor for driving a mixing mechanism in the mixing vessel.

With regard to the prior art described above, one technical problem of the invention is seen as being that of developing a kitchen device of the type in question in such an improved way that there is increased safety for the user.

This object is achieved in first instance and substantially by the subject-matter of claim 1, it being provided that a residual current sensor is disposed in the kitchen device and interrupts the current supply at least of the electric motor if a residual current is detected. As a result of this configuration according to the invention, the user is prevented from receiving an electric shock in the event of a residual current, even in the case of kitchen devices which are generally formed as mobile domestic appliances. If a residual current is detected in the device, the residual current sensor interrupts the current supply, in particular of the units of the device that are under line voltage. In particular, the electric motor for driving the mixing mechanism is switched off by interrupting the current supply. In addition, it is also possible for the entire current supply of the kitchen device to be interrupted by the residual current sensor, with the result that the entire electronics, operating at low voltage, are switched off. In this respect, it is further provided that, in the case of the kitchen device which has an electric cable leading to a power plug, the residual current sensor is disposed inside the kitchen device and surrounding the electric cable.

The invention also relates to an electric motor operated kitchen device, especially a food processor with a mixing vessel, the electric motor being a reluctance motor. Kitchen devices of the type in question are known and generally have a main switch for switching the voltage supply on and off. In this case, the supply line is interrupted by the main switch, with the result that no voltage is available any longer after opening the switch. If the voltage supply of the electric motor, especially the electric motor driving the mixing mechanism in the mixing vessel, is switched off, it runs down unbraked. If an electric motor is used as a direct drive, the running-down time is too long without further measures. In this respect, a method for braking the drive is known from DE 10 035 540 A1. The content of this patent application is hereby incorporated in full in the disclosure of the present invention, including for the purpose of incorporating features of this patent application in claims of the present invention. As a result of this method, energy from the power supply system is required for braking. The voltage supply of the motor control must accordingly also be maintained after the device is switched off, until the electric motor or the mixing mechanism comes to a standstill. To solve this problem, the invention now proposes that the current supply of the reluctance motor is controlled by means of a relay. If the user switches the device off, the current supply of the reluctance motor driving the mixing mechanism is ensured by the relay until the motor comes to a standstill. The relay only interrupts the current supply when the motor has come to a standstill.

Furthermore, further safety measures may also be controlled by the relay. It is conceivable that lifting off of a mixing vessel cover is only made possible after opening of the relay, and accordingly only once the mixing mechanism is at a standstill. A development in which the reluctance motor is electrically braked after switching off is effected by the user, with current continuing to be supplied via the relay, proves to be particularly advantageous. A configuration in which the relay is controlled by a microprocessor which interrupts the current supply when the reluctance motor has come to a standstill proves to be particularly advantageous. This microprocessor additionally also undertakes the control of the motor, the microcontroller switching the reluctance motor to generator operation and at the same time monitoring it when switching off is effected by the user. When the electric motor is at a standstill, and consequently the mixing mechanism is also at a standstill, the relay is switched by means of the microcontroller into a position interrupting the current supply. The solution according to the invention proves to be particularly advantageous in a configuration in which the relay is provided instead of a main switch. Accordingly, no manually operable switch, interrupting the current supply directly, is used. Provided instead is a switch which is to be operated by the user and, by means of the microcontroller, has an effect on the relay, which opens only when the electric motor is at a standstill. Opening of the relay may lead to complete switching-off of the device. However, a preferred configuration is one in which, when the device is connected to the line voltage, the electronics of the device are supplied otherwise independently of a current supply of the reluctance motor by a transformer disposed in the device, with the result that, when switching off of the motor is effected by the user, the remaining electronics of the device, such as for example a weighing means and/or a heating means, continue to be operational. The provision of a standby power supply unit is preferred in this respect. Accordingly, the microcontroller controlling the electric motor is constantly operational. In a development of the subject-matter of the invention, a residual current sensor is disposed in the device and interrupts the current supply at least of the electric motor if a residual current is detected. It is also proposed in this respect that the residual current sensor is disposed inside the kitchen device and surrounding the electric cable. Finally, it also proves to be advantageous that the residual current sensor is interconnected with the relay and/or with the microprocessor, with the result that, in the case of a residual current being detected, safety-relevant switching off takes place by the residual current sensor or DI sensor responding.

The invention is explained in more detail below with reference to the accompanying drawing, which merely represents an exemplary embodiment and in which:

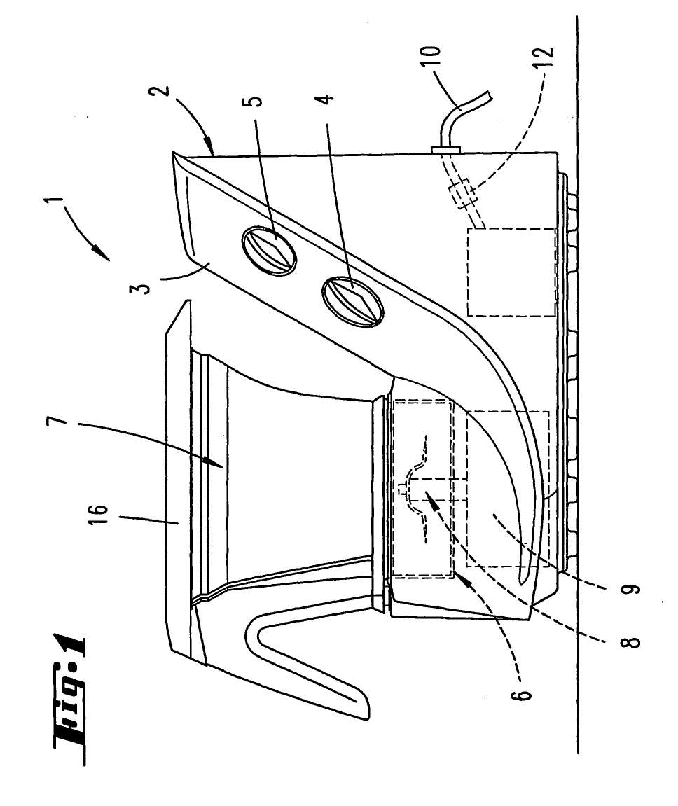

FIG. 1 shows a view of a kitchen device according to the invention, with a mixing vessel and an electric motor for a mixing mechanism in the mixing vessel;

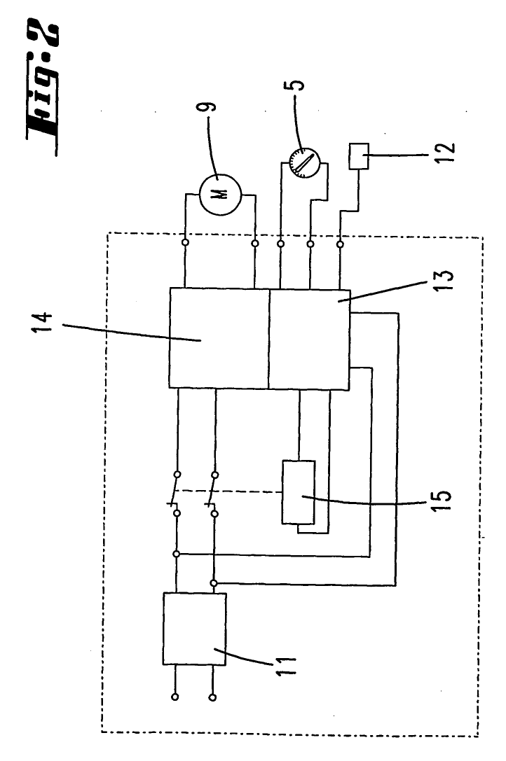

FIG. 2 shows a basic representation of the current supply control of the electric motor.

Represented and described, in first instance with reference to FIG. 1, is a food processor 1 with a housing 2, the latter of which has an operator control panel 3. This operator control panel 3 carries a temperature selector 4 and a speed controller 5. Furthermore, the housing 2 has a receiving region for a mixing vessel 7, forming a mounting adapter 6. Said mixing vessel is heatable.

Provided in the kitchen vessel 7 is a mixing mechanism 8, which is connected by means of a coupling (not represented in any more detail) to an electric motor 9, which can be controlled by means of the speed controller 5, when the kitchen vessel 7 is fitted in the mounting adapter 6. It is preferred here for the electric motor to be a reluctance motor.

The current supply of the kitchen device 1 takes place via an electric cable 10, provided with a power plug (not represented).

A transformer 11 in the form of a standby power supply unit is connected to the electric cable 10 on the inside of the housing.

The electric cable 10, leading to the transformer 11, is surrounded inside the housing 2 by a residual current sensor 12. The latter interrupts the current supply at least of the electric motor 9 if a residual current is detected.

As can be gathered from the schematic representation in FIG. 2, a microcontroller 13 undertakes the control of the electric motor 9, dependent on the setting of the speed controller 5. For this purpose, a control module 14 dependent on the microcontroller 13 is provided.

The switching on and off of the device, especially of the electric motor 9, is performed by using a relay I controlled by means of the microcontroller 13. Said relay is a two-pole relay, by means of which the device, especially the electric motor 9, can be electrically isolated from the power supply system. If switching off is effected by the user, for example by setting the speed controller 5 to a zero position, the microcontroller 13 processing this switching-off command undertakes the control of the motor. For rapid braking of the electric motor 9, it is braked electrically with current continuing to be supplied via the relay 15.

Standstill of the electric motor 9 is detected by the microprocessor 13, which after this makes the relay 15 go over into a position interrupting the current supply to the electric motor 9.

The relay may in this case be disposed in such a way that opening of the same only leads to an interruption of the current to the electric motor 9. This means that the further electronics of the device, such as for example the heating and/or the weighing means of the kitchen device 1, continue to be supplied independently of the current supply of the electric motor 9 by the transformer.11 disposed in the device 1 when the device 1 is connected to the line voltage. However, also conceivable is a solution in which the relay 15 under the control of the microcontroller 13 interrupts the entire current supply of the kitchen device 1 with the exception of that of the microcontroller 13, with the result that the relay 15 forms a main switch for the kitchen device 1. For this function, a switch or button for switching to a standby mode of the device 1 could be additionally provided in the region of the operator control panel 3 of the kitchen device 1.

In addition, safety-relevant switching off may take place by the response of the residual current sensor 12, the signal of which is likewise detected and evaluated by the microcontroller 13.

In an advantageous way, the configuration according to the invention achieves the effect that the device 1 is only switched off once the electric motor 9, or the mixing mechanism 8 driven by it, is at a standstill. Together with the vessel cover 16 which can only be removed when the motor is a standstill, this also has the further advantage that the cover cannot be removed prematurely, even when a residual current causes the device 1 to be switched off, with the result that there is no risk of someone reaching into the still rotating mixing mechanism 8 if the cover 16 is lifted off prematurely.

All disclosed features are (in themselves) pertinent to the invention. The disclosure content of the associated/attached priority documents (copy of the prior patent application) is also hereby incorporated in full in the disclosure of the application, including for the purpose of incorporating features of these documents in claims of the present application.

We claim:

1. Electric motor operated kitchen device (1), especially a food processor, with a mixing vessel (7), the electric motor (9) preferably being a reluctance motor, wherein a residual current sensor (12) is disposed in the kitchen device (1) and interrupts the current supply at least of the electric motor (9) is a residual current is detected.

2. Kitchen device according to claim 1, the kitchen device (1) having an electric cable (10) leading to a power plug, wherein the residual current sensor (12) is disposed inside the kitchen device (1) and surrounding the electric cable (10).

3. Electric motor driven operated device (1), especially a food processor with a mixing vessel (7), the electric motor (9) being a reluctance motor, wherein the current supply of the reluctance motor (9) is controlled by means of a relay (15) and in theat the reluctance motor (9) is electrically braked after switching off is effected by the user, with current continuing to be supplied via the relay (15).

4. Kitchen device according to claim 3, wherein the relay (15) is controlled by a microprocessor (13) which interrupts the current supply when the reluctance motor (9) has come to a standstill.

5. Kitchen device according to claim 3, wherein the relay (15) is provided instead of a main switch.

6. Kitchen device according to claim 3, wherein when the device (1) is connected to the line voltage, the electronics of the device are supplied otherwise independently of a current supply of the reluctance motor (9) by a transformer (11) disposed in the device (1)

7. Kitchen device according to claim 3, wherein a residual current sensor (12) is disposed in the device (1).

8. Kitchen device according to claims 7, the kitchen device (1) having an electric cable (10) leading to a power plug, that wherein the residual current sensor (12) is disposed inside the kitchen device (1) and surrounding the electric cable (10).

9. Kitchen device according to claim 7, wherein the residual current sensor (12) is interconnected with the relay (15) and/or with the microprocessor (13).

10. Kitchen device according to claim 4, wherein the relay (15) is provided instead of a main switch.

11. Kitchen device according to claim 4, wherein, when the device (1) is connected to the line voltage, the electronics of the device are supplied otherwise independently of a current supply of the reluctance motor (9) by a transformer (11) disposed in the device (1).

12. Kitchen device according to claim 5, wherein, when the device (1) is connected to the line voltage, the electronics of the device are supplied otherwise independently of a current supply of the reluctance motor (9) by a transformer (11) disposed in the device (1).

13. Kitchen device according to claim 4, wherein a residual current sensor (12) is disposed in the device (1).

14. Kitchen device according to claim 5, wherein a residual current sensor (12) is disposed in the device (1).

15. Kitchen device according to claim 6, wherein a residual current sensor (12) is disposed in the device (1).

16. Kitchen device according to claim 8, wherein the residual current sensor (12) is interconnected with the relay (15) and/or with the microprocessor (13).

17. Electric motor driven operated device (1), especially a food processor with a mixing vessel (7), the electric motor (9) being a reluctance motor, wherein the current supply of the reluctance motor (9) is controlled by means of a relay (15).
